(19) United States
(12) Patent Application Publication
(10) Pub. No.: US 2024/0354217 A1
(43) Pub. Date: Oct. 24, 2024

(54) PAUSE, RESUME, AND REPLAY FUNCTIONS FOR PIPELINE EXECUTION IN AN ORCHESTRATION FRAMEWORK

(71) Applicant: GM Cruise Holdings LLC, San Francisco, CA (US)

(72) Inventors: Horton Koon-Ho Lo, Palo Alto, CA (US); Samuel Ben Hansen, San Francisco, CA (US)

(21) Appl. No.: 18/306,138

(22) Filed: Apr. 24, 2023

(51) Int. Cl. G06F 11/34; G06F 9/38

(52) U.S. Cl. CPC G06F 11/3476; G06F 9/48; G06F 9/4868; G06F 9/50; G06F 9/5038; G06F 2209/508

(57) ABSTRACT

Systems and techniques are provided for controlling execution of pipelines in an orchestration framework. An example method includes receiving, by a resolver in an orchestration framework, a pause request for stopping execution of a first pipeline that includes a plurality of nodes; identifying at least one active node from the plurality of nodes that is currently executing; sending a pause command to the at least one active node from the plurality of nodes in the first pipeline; receiving paused state data that is associated with the at least one active node, wherein the paused state data corresponds to an intermediate execution state of the at least one active node; and sending pipeline checkpoint data corresponding to the first pipeline, wherein the pipeline checkpoint data includes the paused state data associated with the at least one active node.

### BACKGROUND

### 1. Technical Field

The present disclosure generally relates to autonomous vehicles and, more specifically, to an orchestration framework that provides pause, resume, and replay functions for pipeline execution that can be used for development of autonomous vehicle software.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. The internal computing system of the autonomous vehicle may be configured to implement different software algorithms such as machine learning models that can be developed using orchestration frameworks configured to execute software pipelines.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, according to some examples of the present disclosure;

FIG. 2 is a diagram illustrating aspects of an example orchestration framework for implementing pause, resume, and replay functions for pipeline execution, according to some examples of the present disclosure;

FIG. 3 is a diagram illustrating an example pipeline that may be paused, resumed, and/or replayed, according to some examples of the present disclosure;

FIG. 4 is a flowchart illustrating an example process for implementing pause, resume, and replay functions for pipeline execution, according to some examples of the present disclosure;

FIG. 5 is another flowchart illustrating an example process for implementing pause, resume, and replay functions for pipeline execution, according to some examples of the present disclosure;

FIG. 6 is another flowchart illustrating an example process for implementing pause, resume, and replay functions for pipeline execution, according to some examples of the present disclosure;

FIG. 7 is another flowchart illustrating an example process for implementing pause, resume, and replay functions for pipeline execution, according to some examples of the present disclosure; and

FIG. 8 is a diagram illustrating an example system architecture for implementing certain aspects described herein, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and navigate the environment without human input (or with minimal human input). Automation technologies enable AVs to drive on roadways and perceive the surrounding environment accurately and quickly, including obstacles, signs, road users and vehicles, traffic lights, semantic elements, boundaries, among others. In some cases, AVs can be used to pick-up passengers and/or cargo and drive the passengers and/or cargo to selected destinations.

AV navigation systems may include many different software algorithms that implement different functions. For example, an AV navigation system may include a perception stack that can include a machine learning model configured to process data from AV sensors (e.g., LIDAR data, camera data, RADAR data, etc.) in order to identify objects within the environment of the AV. Another example of a software algorithm within the AV may include a prediction stack that can include a machine learning model configured to predict future paths of objects within the environment of AV.

In some cases, development of the various software algorithms (e.g., machine learning models, heuristic models, etc.) that are implemented by the AV can be a long and costly process. That is, software development may utilize a great deal of time and computing resources. Moreover, a change to the software may result in further delays because steps in the pipeline may need to be unnecessarily repeated.

Systems, apparatuses, processes (also referred to as methods), and computer-readable media (collectively referred to as “systems and techniques”) are described herein for implementing an orchestration framework that includes pause, resume, and/or replay functions for controlling pipeline execution. In some aspects, an orchestration framework may include an Application Programming Interface (API) server that can be configured to receive user input that includes requests for execution of new pipelines; requests to pause execution of pipeline(s); requests to resume execution of pipeline(s); and/or request to replay execution of pipeline(s). In some examples, the API server can allocate compute resources (e.g., memory, processing, etc.) for pipeline execution and initiate the pipeline(s).

In some examples, the orchestration framework may include a resolver that can be configured to monitor and manage execution of a pipeline (e.g., the resolver can execute a state machine that monitors pipeline execution). In some cases, the resolver can be configured to gather state information corresponding to the pipeline and/or the nodes within the pipeline. For example, the resolver can be configured to collect checkpoint data that includes input/output data for each node within a pipeline. In some cases, the resolver may send the checkpoint data to the API server for storage to facilitate future requests for replay execution of the pipeline and/or resuming execution of the pipeline.

In some aspects, the resolver can issue a pause instruction to a pipeline and/or an active node within a pipeline. In some cases, the pause command can cause the active node to pause its current function and gather and store data corresponding to an intermediate execution state. For example, a node may collect data corresponding to the current epoch while training a machine learning model. The node may send the data associated with the intermediate execution state to the resolver for storage and future retrieval.

In some cases, the API server may receive a resume request, or a replay request associated with a pipeline that has been paused or a pipeline that has completed its execution. In some instances, the API server may retrieve configuration data associated with the pipeline and create a clone of the pipeline to facilitate resume and/or replay functionality. For example, a programmer may make changes to the code corresponding to one or more nodes in the pipeline and initiate a resume or replay request to test the changes in the code.

In some examples, the resume request can be processed, and the cloned pipeline may be scheduled for execution (e.g., using cloud compute resources) by the API server. In some cases, execution may be resumed commencing at the intermediate execution state that was previously paused. In some instances, execution may be replayed commencing at any state prior to the intermediate execution state associated with a pause and/or from the start of any node that has previously been executed.

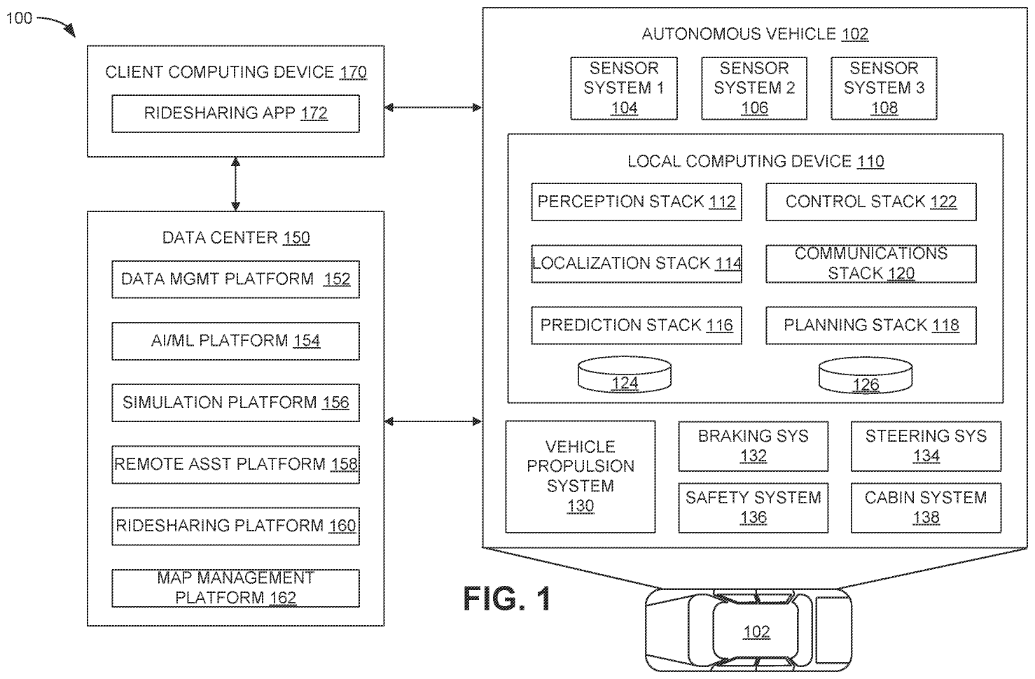

FIG. 1 is a diagram illustrating an example autonomous vehicle (AV) environment system 100, according to some examples of the present disclosure. One of ordinary skill in the art will understand that, for the AV environment system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LiDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LiDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LiDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LiDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LiDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the ridesharing application 172 to enable passengers to view the AV 102 in transit to a pick-up or drop-off location, and so on.

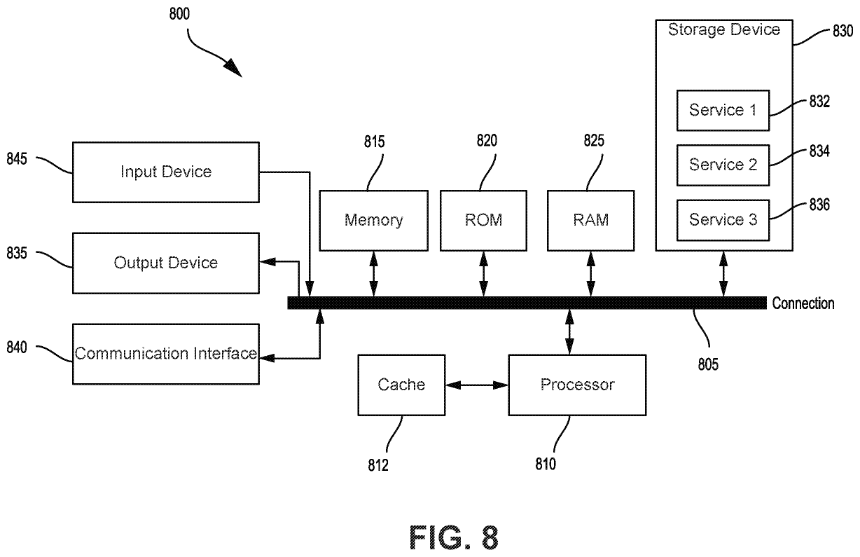

While the AV 102, the local computing device 110, and the AV environment system 100 are shown to include certain systems and components, one of ordinary skill will appreciate that the AV 102, the local computing device 110, and/or the AV environment system 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 8.

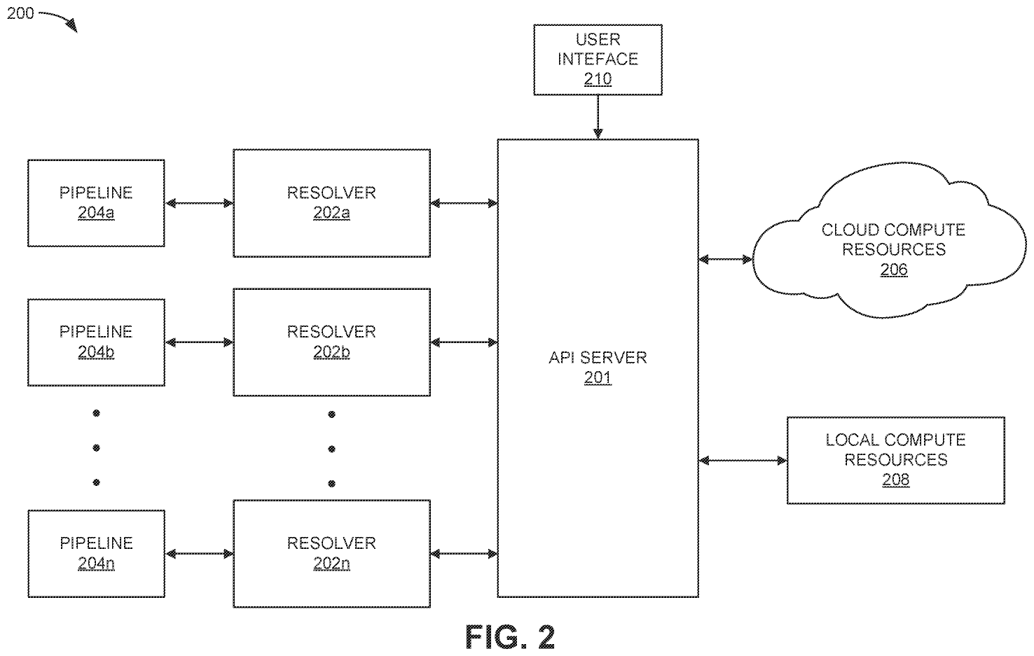

FIG. 2 is a system diagram illustrating an orchestration framework 200 that may be used for implementing pause, resume, and replay functions for pipeline execution. In some aspects, orchestration framework 200 may include an Application Programming Interface (API) server 201. In some cases, the API server 201 may be associated with a user interface 210 that can be used to instantiate, configure, control, and/or monitor the execution of one or more pipelines such as pipeline 204a, pipeline 204, and/or pipeline 204n (collectively referred to as “pipelines 204”). In some aspects, the user interface 210 can be used to submit commands to one or more of pipelines 204 such as a pause command, a replay command, and/or a resume command.

In some aspects, orchestration framework 200 may include one or more resolvers such as resolver 202a, resolver 202b, and/or resolver 202n (collectively referred to as “resolvers 202”). In some aspects, each of the resolvers 202 can be associated with one of the pipelines 204. For example, resolver 202a can be associated with pipeline 204a; resolver 202b can be associated with pipeline 204b; and resolver 202n can be associated with pipeline 204n. In some cases, resolvers 202 and/or API server 201 may be implemented using one or more components of a processor-based system such as processor-based system 800 discussed further below.

In some examples, resolvers 202 can include a state machine that can be used to monitor, control, and/or manage execution of one or more pipelines 204. For instance, in some cases, resolvers 202 may implement an algorithm that identifies a Future, which can include an awaitable object corresponding to an eventual result of an asynchronous operation (e.g., an output of one or more pipelines 204). In some instances, resolvers 202 may operate in a continuous loop that monitors the state of pipelines 204.

In some examples, API server 201 can allocate compute resources to resolvers 202 and/or pipelines 204 such as cloud compute resources 206 and local compute resources 208. In one illustrative example, API serve 201 may create a KUBERNETES™ job (e.g., within cloud compute resources 206) for one or more of pipelines 204 upon determining that all input values to pipelines 204 are resolved (e.g., available for processing).

In some aspects, pipelines 204 may include multiple blocks or nodes of code that are interconnected. In some cases, each block of code or node within a pipeline (e.g., pipelines 204) may correspond to a function, routine, subprogram, subroutine, method, process, task, procedure, object, etc. In some examples, each block or node within a pipeline may be referred to as a transformer. In some instances, the transformers within a pipeline may be nested (e.g., a transformer may include another transformer, etc.).

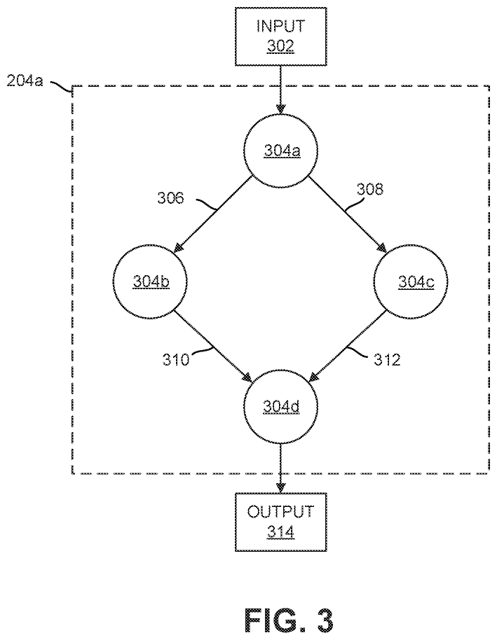

FIG. 3 illustrates an example of a pipeline 204a (e.g., from pipelines 204). As illustrated, pipeline 204a includes node 304a, node 304b, node 304c, and node 304d. In some aspects, node 304a may receive input 302 and generate output 306 and output 308. In some cases, node 304b can receive output 306 from node 304a as an input and generate output 310; and node 304c can receive output 308 from node 304a as an input and generate output 312. In some configurations, node 304d can receive output 310 from node 304b as an input and output 312 from node 304c as an input and node 304d can generate output 314.

As noted above, each of the nodes in pipeline 204a (e.g., node 304a, node 304b, node 304c, and/or node 304d) can be nested and include multiple nodes. In one illustrative example, pipeline 204a may correspond to a pipeline for training a machine learning model and the nodes (e.g., node 304a, node 304b, node 304c, and/or node 304d) may correspond to functions such as generating training data, training the machine learning model, evaluating the machine learning model, obtaining metrics from the machine learning model, etc.

Returning to FIG. 2, resolvers 202 may monitor the status of pipelines 204 (e.g., resolver 202a can monitor the status of pipeline 204a; resolver 202b can monitor the status of pipeline 204b; etc.). For example, resolver 202a may generate one or more checkpoints corresponding to pipeline 204a and/or to the nodes therein. In some cases, resolver 202a may generate a checkpoint by tracking and storing the state/value of each input/output of pipeline 204a or a node. In one illustrative example, a checkpoint for pipeline 204a may include input 302 and output 314. In another example, a checkpoint for node 304a may include input 302, output 306, and output 308. In some configurations, resolver 202a may automatically persist checkpoints to cloud storage (e.g., cloud compute resources 206) and/or local storage (e.g., local compute resources 208) directly (not illustrated) or through API server 201.

In some cases, resolver 202a may maintain and update one or more tables or graphs that indicate the status of pipeline 204a. For example, resolver 202a may maintain a directed acyclic graph (DAG) that includes the checkpoints for each node in the pipeline 204a. In some aspects, resolver 202a may use a DAG to determine the status of a node or pipeline (e.g., executing, complete, waiting on ‘x’ input(s), etc.).

In some examples, API server 201 may receive a request (e.g., from user interface 210) to pause execution of a pipeline (e.g., pipeline 204a). In response to the request to pause execution, API server 201 may issue a pause command to resolver 202a that is associated with pipeline 204a. In some aspects, resolver 202a may then issue a pause command directly to a node that is currently executing within pipeline 204a.

In some cases, the nodes within pipeline 204a (e.g., node 304a, node 304b, node 304c, and/or node 304d) can include an application programming interface (API) that is configured to receive and process the pause command. For example, the API that processes the pause command may invoke a function within a node that causes the node to stop execution and save data associated with an intermediate execution state. In some aspects, the data associated with the intermediate execution state may include any type of data that is associated with the node (e.g., training data, weights associated with a machine learning model, random number iteration, etc.). In one illustrative example, the pause command may be received by a node that is currently performing the second epoch (e.g., second training pass) and the node may store data corresponding to the intermediate state of the second epoch (e.g., updated weights).

In some cases, a node that receives the pause command may store data corresponding to a prior intermediate state and discard data generated after that prior state. For instance, returning to the example of the node executing the second epoch, the node may store data corresponding to the completed first epoch and discard the data corresponding to the unfinished second epoch. Those skilled in the art will recognize that a node in a pipeline may be configured to store data corresponding to any function and/or any intermediate execution state.

In some aspects, the node or pipeline (e.g., pipeline 204a) can send the data corresponding to the intermediate execution state to resolver 202a. In some aspects, resolver 202a may store the data corresponding to the intermediate execution state (e.g., paused state) within cloud compute resources 206 and/or local compute resources 208. In some instances, resolver 202a may send the data corresponding to the intermediate execution state (e.g., paused state) to API server 201, which can then store the data in cloud compute resources 206 and/or local compute resources 208.

In some instances, API server 201 may receive a request (e.g., from user interface 210) to resume execution of one or more of pipelines 204. In some aspects, API server 201 may retrieve configuration data associated with a pipeline (e.g., pipeline 204a) from cloud compute resources 206 and/or local compute resources 208. The configuration data can include the data corresponding to an intermediate execution state for a node in a pipeline and/or the checkpoint(s) for one or more nodes in a pipeline. In some examples, API server 201 may use the configuration data and/or the checkpoint data to generate a clone of a previously paused pipeline. In some instances, API server 201 may schedule cloud compute resources 206 and/or local compute resources 208 for resuming execution of the cloned and previously paused pipeline. In some aspects, the pipeline may resume execution from the point corresponding to the intermediate execution state of a node. For example, pipeline 204a may resume execution from an intermediate state of node 304c.

In some examples, API server 201 may receive a request (e.g., from user interface 210) to replay a pipeline that has been paused or a pipeline that has finished executing (e.g., all nodes have completed execution). For example, pipeline 204a may have been paused while node 304b was executing and after node 304a completed execution. In some cases, a user or programmer may make changes to code associated with a node that has completed execution and may wish to replay the execution. For instance, a programmer may change code associated with node 304a after node 304a has completed execution. In some cases, API server 201 may retrieve configuration data corresponding to pipeline 204a and generate a copy or clone to facilitate replay functionality. In some examples, the replay function may be implemented such that pipeline 204a repeats portions that previously executed. For instance, pipeline 204a can be replayed by commencing execution of node 304a.

In some configurations, API server 201 may monitor the status of one or more compute resources such as cloud compute resources 206 and/or local compute resources 208. In some cases, API server 201 may determine that resources are limited and a pipeline awaiting execution is associated with a higher priority metric than a pipeline that is currently executing. In some instances, API server 201 may send a pause command to one of the resolvers 202 to pause a corresponding pipeline that is currently executing in order to obtain compute resources for another pipeline that is awaiting execution.

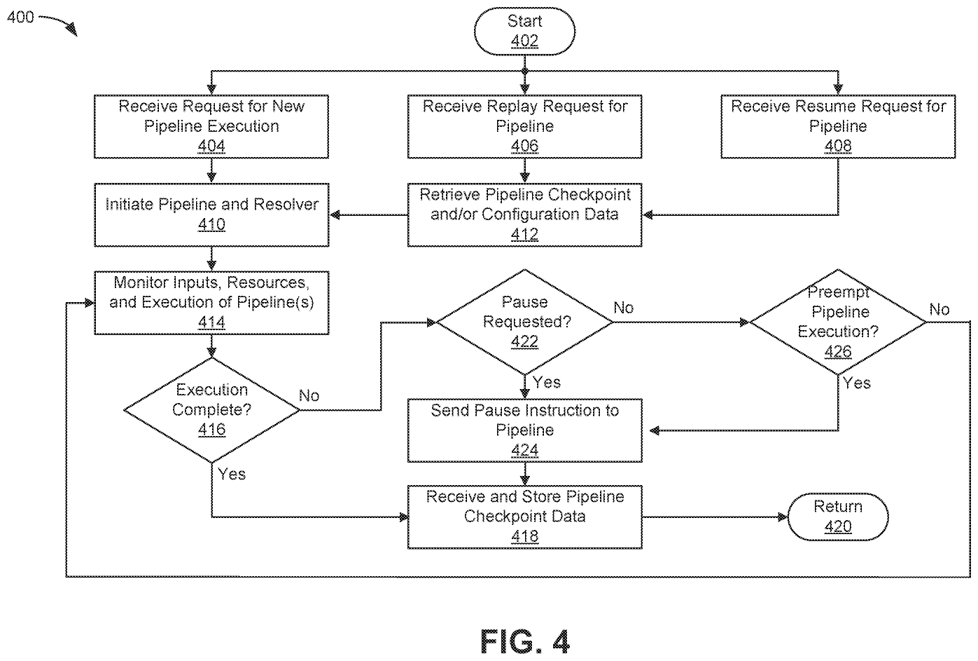

FIG. 4 is a flowchart diagram illustrating an example process 400 for implementing pause, resume, and/or replay functions for pipeline execution within an orchestration framework. In some cases, one or more steps from process 400 may be performed by an API server within an orchestration framework such as API server 201. In some aspects, process 400 may start at step 402, which may include initializing of hardware or software systems associated with an orchestration framework (e.g., orchestration framework 200) and/or with any other component or device that may be configured to execute one or more steps in process 400.

In some examples, process 400 may commence upon receiving one or more asynchronous inputs. For example, step 404 may include receiving a request for new pipeline execution. For instance, an API server (e.g., API server 201) may receive user input (e.g., via user interface 210) requesting execution of a new pipeline. In another example, step 406 may include receiving a request to replay all or a portion of a pipeline. For instance, an API server (e.g., API server 201) may receive user input (e.g., via user interface 210) requesting replay of all or a portion of a previously executed pipeline. In another example, step 408 may include receiving a request to resume execution of a pipeline. For instance, an API server (e.g., API server 201) may receive user input (e.g., via user interface 210) requesting resumption of a pipeline that has been paused.

In some cases, in which a replay request is received at step 406, or a resume request is received at step 408, the process 400 may proceed to step 412 and retrieve pipeline checkpoint data and/or pipeline configuration data. For example, an API server can retrieve configuration data associated with a pipeline and configure the pipeline for replay and/or resume functionality. In some aspects, replay of the pipeline may be initiated from the start of any of the nodes within the pipeline. In some cases, the resolver may generate a copy or clone of the pipeline to perform the replay. In some cases, if a resume request was received, the API server may retrieve pipeline configuration data that may include data corresponding to an intermediate execution state of one or more nodes within a pipeline. In some configurations, the API server may generate a clone or copy of the pipeline that can be used to resume execution. In some instances, execution may be resumed from the point in the code where a pause occurred (e.g., an intermediate execution state within a node) and/or from an earlier point such as in a replay scenario.

In some aspects, the process may proceed to step 410 in which an API server may initiate a resolver and a corresponding pipeline for execution (e.g., after a request for a new pipeline at step 404 or after retrieving pipeline checkpoint data for resume/replay functionality at step 412). In some cases, initiation of a resolver and/or pipeline may include allocating compute resources for execution of the resolver and/or pipeline. For instance, API server 201 may allocate cloud compute resources 206 (e.g., memory, processing, etc.) and/or local compute resources 208 for execution of the pipeline. As noted above, in some aspects, the API server may create a copy or clone of a pipeline that was previously stored in order to facilitate replay or resume functions.

In some cases, the process 400 may proceed to step 412, which may include monitoring execution of one or more pipelines. For instance, an API server (e.g., API server 201) may monitor execution of pipelines 204 by communicating with resolvers 202. In some cases, resolvers 202 may send data that includes pipeline execution status to the API server (e.g., estimated time remaining, etc.)

At step 416, the process 400 can include determining whether execution of pipeline(s) is complete. If execution is complete, the process 400 can proceed to step 418 and receive and store the pipeline configuration data and/or pipeline checkpoints. For example, an API server can receive pipeline configuration data and/or pipeline checkpoint data from a resolver, and the API server can store the data associated with a pipeline using local or cloud compute resources. In some aspects, the process 400 can proceed to step 420 and return to prior processing, which may include repeating one or more steps from process 400.

Returning to step 416, if execution of the pipeline is not complete, the process 400 may proceed to step 422 and determine whether a pause request was received. In some cases, a pause request may be submitted via a user interface (e.g., user interface 210) of an orchestration framework. In some aspects, if a pause request is not received, the process 400 can proceed to step 426 and determine whether pipeline execution should be preempted. In one illustrative example, an API server can monitor usage of compute resources and determine whether capacity is limited. In some cases, the API server may determine that a pipeline awaiting execution has higher priority than a pipeline that is currently executing. In some instances, the API server may preempt execution of a pipeline in order to reallocate compute resources and/or to prioritize execution of different pipelines. However, if pipeline execution does not need to be preempted, the process 400 can return to step 414 and continue monitoring execution of pipeline(s)

In some cases, if a pause command is received (e.g., at step 422) or pipeline execution needs to be preempted (e.g., at step 426), the process 400 may proceed to step 424 and send a pause command to a pipeline (e.g., an API server can send a pause command to a resolver associated with a pipeline). In some examples, the pause command may be processed by the resolver to cause one or more nodes in the executing pipeline to pause. For example, a node that is currently executing may receive the pause command from the resolver and cause data corresponding to an intermediate execution state to be sent to the API server. That is, the node that is executing within the pipeline that is being paused can halt execution and send data to a resolver, which can then send it to the API server so that the pipeline can be reloaded and/or execution can be resumed from its current state.

At step 418, the process 400 can include receiving and storing pipeline checkpoint data and/or configuration data. For example, the API server may receive pipeline configuration data that includes data corresponding to an intermediate execution state from one or more nodes within a pipeline. In some aspects, the API server may store the pipeline configuration data (e.g., using local and/or cloud storage resources). In some examples, the pipeline configuration data may include checkpoint information for the nodes within the pipeline. In some cases, the checkpoint data may include input/output data. In some examples, the output data may correspond to a Future (e.g., an eventual result of an asynchronous operation). In some examples, the process 400 may proceed to step 420 and return to prior processing, which may include repeating one or more steps from process 400.

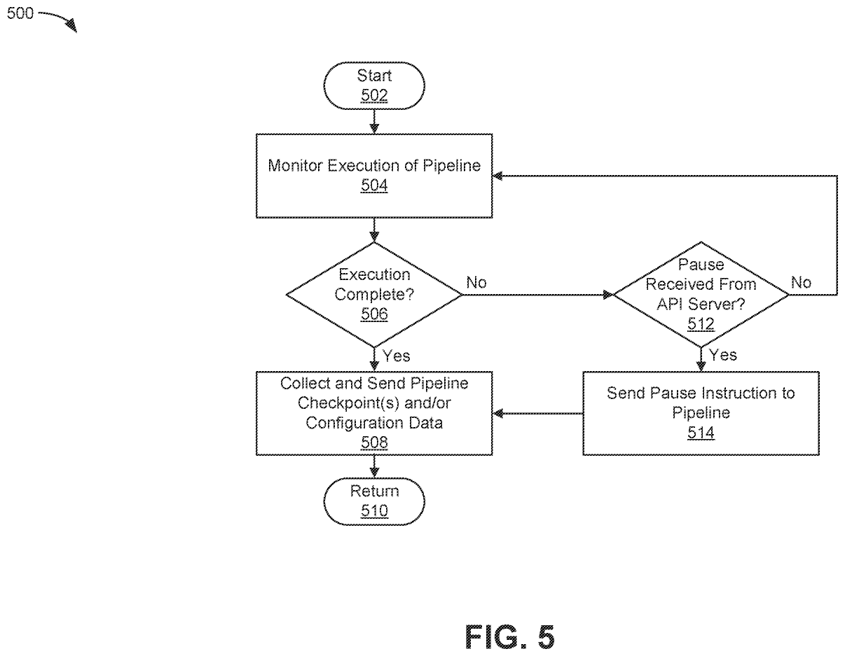

FIG. 5 is a flowchart diagram illustrating an example process 500 for implementing pause, resume, and/or replay functions for pipeline execution within an orchestration framework. In some cases, one or more steps from process 500 may be performed by a resolver within an orchestration framework such as resolvers 202 in orchestration framework 200. In some aspects, process 500 may start at step 502, which may include initializing of hardware or software systems associated with an orchestration framework (e.g., orchestration framework 200) and/or with any other component or device that may be configured to execute one or more steps in process 500.

At step 504, the process 500 can include monitoring execution of a pipeline. For example, resolver 202a may monitor execution of pipeline 204a. In some cases, a resolver may monitor execution of a pipeline to determine status of nodes (e.g., executing, completed, etc.), inputs/outputs, time executing, estimated time remaining, memory usage, compute usage, compute allocation, etc. In some cases, a resolver may maintain or update a DAG for each pipeline. In some examples, a resolver may schedule compute resources for execution of a pipeline or node that is ready to execute (e.g., all inputs are resolved).

In some examples, the process 500 may proceed to step 506 to determine if pipeline execution is complete. If the pipeline execution has been completed, the process 500 can proceed to step 508 in which the resolver can collect and send pipeline checkpoint data and/or pipeline configuration data. In some cases, the pipeline checkpoint data can include input/output data associated with one or more nodes in a pipeline. In some examples, the pipeline checkpoint data and/or the pipeline configuration data may include data associated with an intermediate execution state (e.g., a node that has not completed execution). In some cases, the resolver can send the checkpoint data and/or the configuration data to an API server for storage such that the checkpoint data and/or configuration data can be retrieved to facilitate replay and/or resume functions.

In some cases, if execution has not been completed, the process 500 may proceed to step 512 to determine whether a pause command has been received by the resolver from the API server (e.g., pursuant to user input and/or to preempt pipeline execution). In some examples, the process 500 can proceed to step 514 in which the resolver can send a pause instruction to the pipeline (e.g., to one or more nodes within the pipeline). In some aspects, the pause command may be processed by one or more nodes in the pipeline that is being paused. For example, a node that is currently executing may receive the pause command and cause data corresponding to an intermediate execution state to be saved (e.g., via the resolver and/or the API server). That is, at step 508, the node that is executing within the pipeline that is being paused can halt execution and send checkpoint data and/or configuration data to a resolver. In some cases, that checkpoint data and/or configuration data can be used to reload or resume execution of the pipeline from its current state. In some instances, the process 500 may then proceed to step 510 and return to prior processing, which may include repeating one or more steps from process 500.

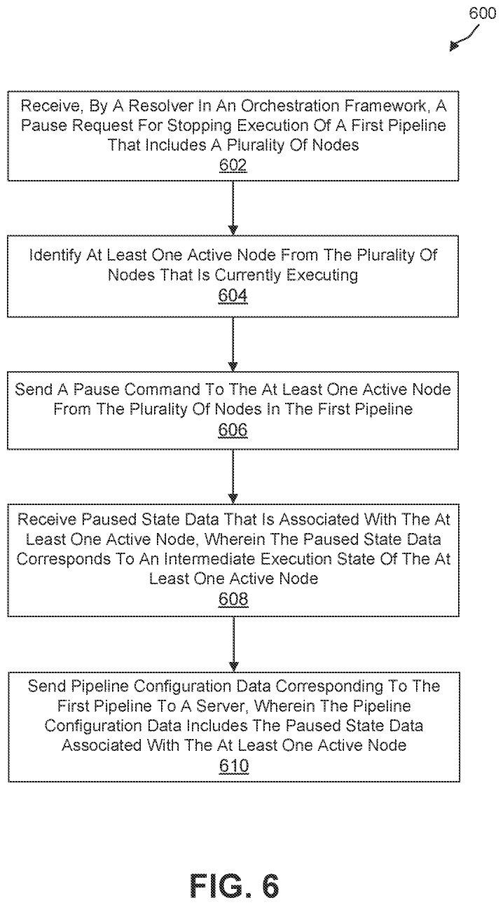

FIG. 6 illustrates a flowchart of an example process 600 for implementing pause, resume, and/or replay functions for pipeline execution within an orchestration framework. At step 602, the process 600 includes receiving, by a resolver in an orchestration framework, a pause request for stopping execution of a first pipeline that includes a plurality of nodes. For example, resolver 202a may receive a pause request (e.g., from API server 201) for stopping execution of a pipeline 204a that includes node 304a, node 304b, node 304c, and node 304d.

At step 604, the process 600 includes identifying at least one active node from the plurality of nodes that is currently executing. For example, resolver 202a may determine that node 304c is active (e.g., executing) and that node 304a and node 304b have completed execution while node 304d is waiting for node 304c to complete before it is able to execute. In some instances, the at least one active node from the plurality of nodes can be identified based on a directed acyclic graph (DAG) that is associated with the first pipeline. For example, resolver 202a may identify node 304c as the active node based on a DAG that is associated with pipeline 204a.

At step 606, the process 600 includes sending a pause command to the at least one active node from the plurality of nodes in the first pipeline. For instance, resolver 202a can send a pause command to node 304c (e.g., the at least one active node).

At step 608, the process 600 includes receiving paused state data that is associated with the at least one active node, wherein the paused state data corresponds to an intermediate execution state of the at least one active node. For example, resolver 202a may receive paused state data that is associated with node 304c. In some aspects, the paused state data can correspond to an intermediate execution state of node 304c. In some examples, the paused state data can include at least one of a machine learning model, machine learning model weights, input data received by the at least one active node, output data generated by the at least one active node, and data corresponding to a last completed epoch.

At step 610, the process 600 includes sending pipeline checkpoint data corresponding to the first pipeline to a server, wherein the pipeline checkpoint data includes the paused state data associated with the at least one active node. For instance, resolver 202a may send pipeline checkpoint data corresponding to pipeline 204a to API server 201. In some cases, the pipeline checkpoint data can include the paused state data associated with node 304c. In some aspects, the pipeline checkpoint data can include input data and output data corresponding to each of the plurality of nodes. For example, the pipeline checkpoint data corresponding to pipeline 204a can include input 302, output 306, and output 308 corresponding to node 304a.

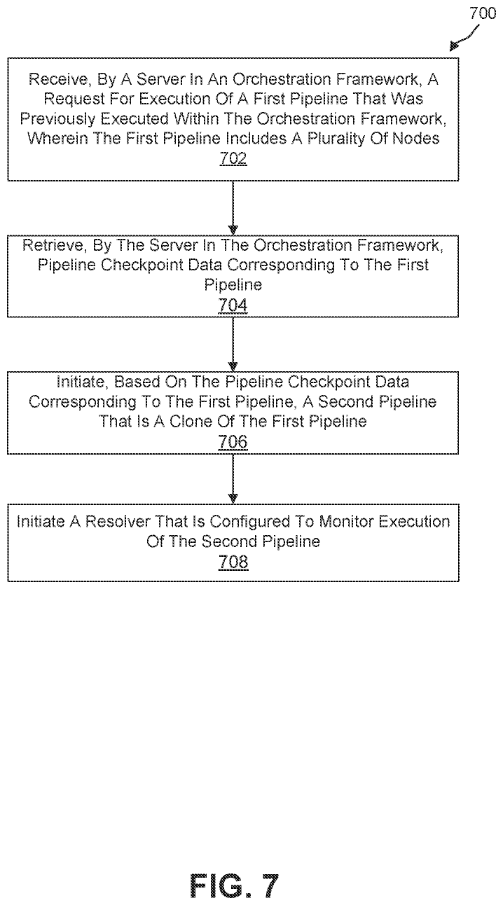

FIG. 7 illustrates a flowchart of an example process 700 for implementing pause, resume, and/or replay functions for pipeline execution within an orchestration framework. At step 702, the process 700 includes receiving, by a server in an orchestration framework, a request for execution of a first pipeline that was previously executed within the orchestration framework, wherein the first pipeline includes a plurality of nodes. For example, API server 201 can receive a request (e.g., via user interface 210) for execution of pipeline 204a that was previously executed within orchestration framework 200.

At step 704, the process 700 includes retrieving, by the server in the orchestration framework, pipeline checkpoint data corresponding to the first pipeline. For instance, API server 201 can retrieve pipeline checkpoint data corresponding to pipeline 204a from cloud compute resources 206 and/or local compute resources 208. In some cases, the pipeline checkpoint data includes input data and output data corresponding to each of a plurality of nodes in the first pipeline. In some aspects, the pipeline checkpoint data can include paused state data that corresponds to an intermediate execution state, and the paused state data can include at least one of a machine learning model, machine learning model weights, input data received by the at least one node, output data generated by the at least one node, and data corresponding to a last completed epoch.

At step 706, the process 700 includes initiating, based on the pipeline checkpoint data corresponding to the first pipeline, a second pipeline that is a clone of the first pipeline. For example, API server 201 may initiate (e.g., generate, instantiate, etc.) pipeline 204b (e.g., second pipeline) which may be a clone of pipeline 204a that was previously executed. API server 201 may create the copy or duplicate of pipeline 204a using the pipeline checkpoint data retrieved from storage.

At step 708, the process 700 includes initiating a resolver that is configured to monitor execution of the second pipeline. For instance, API server 201 may initiate resolver 202b, which may be configured to monitor execution of pipeline 204b.

In some examples, the request may correspond to a resume request for restarting execution of the first pipeline from an intermediate execution state of at least one node from the plurality of nodes in the first pipeline. For example, API server 201 can receive a resume request for resuming execution of pipeline 204a. In some aspects, the process 700 may include allocating compute resources for execution of the second pipeline, wherein the second pipeline is configured to commence execution from a resume state corresponding to the intermediate execution state of the at least one node. For example, API server 201 can allocate cloud compute resources 206 and schedule execution of the pipeline 204b (e.g., copy of pipeline 204a). In some cases, execution may resume from the intermediate execution state of node 304c.

In some instances, the request may correspond to a replay request for repeating execution of at least a portion of the first pipeline. For example, API server 201 may receive a replay request for replaying at least a portion of pipeline 204a. In some aspects, the process 700 can include allocating compute resources for execution of the second pipeline, wherein the second pipeline is configured to commence execution from a replay state that is prior to an intermediate execution state of at least one node that was active during a pause request, wherein the pause request was received while the first pipeline was previously executed within the orchestration framework. For example, API server 201 can allocate cloud compute resources 206 for execution of pipeline 204b from a replay state that is prior to the intermediate execution state corresponding to node 304c. For instance, replay may be initiated commencing with the start of node 304c. In some cases, the replay state that is prior to the intermediate execution state of the at least one active node corresponds to at least one other node from the plurality of nodes, wherein the at least one other node completed execution prior to the pause request. For example, the replay may be initiated commencing with the start of node 304a which completed execution prior to the pause request.

In some examples, the process 700 can include determining that a third pipeline awaiting execution has a higher priority than the first pipeline; sending a pause instruction to the second pipeline; and allocating one or more compute resources to the third pipeline after sending the pause instruction. For instance, API server 201 may determine that a third pipeline (e.g., pipeline 204c) has a higher priority than pipeline 204b. In some cases, API server 201 may send a pause command to pipeline 204b to free up compute resources such that the pipeline with a higher priority (e.g., pipeline 204c) can be executed without further delay.

FIG. 8 illustrates an example processor-based system with which some aspects of the subject technology can be implemented. For example, processor-based system 800 can be any computing device making up local computing device 110, client computing device 170, a passenger device executing the ridesharing application 172, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, in close proximity to, and/or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 can include an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 830 can include software services, servers, services, etc., that when the code that defines such software is executed by the processor 810, causes the system to perform a function. In some examples, a hardware service that performs a particular function can include the software component stored in a computer-readable medium in connection with the necessary hardware components, such as processor 810, connection 805, output device 835, etc., to carry out the function.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: receiving, by a server in an orchestration framework, a request for execution of a first pipeline that was previously executed within the orchestration framework, wherein the first pipeline includes a plurality of nodes; retrieving, by the server in the orchestration framework, pipeline checkpoint data corresponding to the first pipeline; initiating, based on the pipeline checkpoint data corresponding to the first pipeline, a second pipeline that is a clone of the first pipeline; and initiating a resolver that is configured to monitor execution of the second pipeline.

Aspect 2. The method of Aspect 1, wherein the request corresponds to a resume request for restarting execution of the first pipeline from an intermediate execution state of at least one node from the plurality of nodes in the first pipeline.

Aspect 3. The method of Aspect 2, further comprising: allocating compute resources for execution of the second pipeline, wherein the second pipeline is configured to commence execution from a resume state corresponding to the intermediate execution state of the at least one node.

Aspect 4. The method of any of Aspects 2 to 3, wherein the pipeline checkpoint data includes paused state data that corresponds to the intermediate execution state, and wherein the paused state data includes at least one of a machine learning model, machine learning model weights, input data received by the at least one node, output data generated by the at least one node, and data corresponding to a last completed epoch.

Aspect 5. The method of Aspect 4, wherein the paused state data includes at least one of a machine learning model, machine learning model weights, input data received by the at least one node, output data generated by the at least one node, and data corresponding to a last completed epoch.

Aspect 6. The method of Aspect 1, wherein the request corresponds to a replay request for repeating execution of at least a portion of the first pipeline.

Aspect 7. The method of Aspect 6, further comprising: allocating compute resources for execution of the second pipeline, wherein the second pipeline is configured to commence execution from a replay state that is prior to an intermediate execution state of at least one node that was active during a pause request, wherein the pause request was received while the first pipeline was previously executed within the orchestration framework.

Aspect 8. The method of any of Aspects 6 to 7, wherein the replay state that is prior to the intermediate execution state of the at least one node corresponds to at least one other node from the plurality of nodes, wherein the at least one other node completed execution prior to the pause request.

Aspect 9. The method of any of Aspects 1 to 8, wherein the pipeline checkpoint data includes input data and output data corresponding to each of a plurality of nodes in the first pipeline.

Aspect 10. An apparatus comprising: at least one memory; and at least one processor coupled to the at least one memory, wherein the at least one processor is configured to perform operations in accordance with any one of Aspects 1 to 9.

Aspect 11. An apparatus comprising means for performing operations in accordance with any one of Aspects 1 to 9.

Aspect 12. A non-transitory computer-readable medium comprising instructions that, when executed by an apparatus, cause the apparatus to perform operations in accordance with any one of Aspects 1 to 9.

Aspect 13. A method comprising: receiving, by a resolver in an orchestration framework, a pause request for stopping execution of a first pipeline that includes a plurality of nodes; identifying at least one active node from the plurality of nodes that is currently executing; sending a pause command to the at least one active node from the plurality of nodes in the first pipeline; receiving paused state data that is associated with the at least one active node, wherein the paused state data corresponds to an intermediate execution state of the at least one active node; and sending pipeline checkpoint data corresponding to the first pipeline to a server, wherein the pipeline checkpoint data includes the paused state data associated with the at least one active node.

Aspect 14. The method of Aspect 13, wherein the at least one active node from the plurality of nodes is identified based on a directed acyclic graph that is associated with the first pipeline.

Aspect 15. The method of any of Aspects 13 to 14, wherein the pipeline checkpoint data includes input data and output data corresponding to each of the plurality of nodes.

Aspect 16. The method of any of Aspects 13 to 15, wherein the paused state data includes at least one of a machine learning model, machine learning model weights, input data received by the at least one active node, output data generated by the at least one active node, and data corresponding to a last completed epoch.

Aspect 17. An apparatus comprising: at least one memory; and at least one processor coupled to the at least one memory, wherein the at least one processor is configured to perform operations in accordance with any one of Aspects 13 to 16.

Aspect 18. An apparatus comprising means for performing operations in accordance with any one of Aspects 13 to 16.

Aspect 19. A non-transitory computer-readable medium comprising instructions that, when executed by an apparatus, cause the apparatus to perform operations in accordance with any one of Aspects 13 to 16.

What is claimed is:

1. A system comprising:
a memory; and
one or more processors coupled to the memory, the one or more processors being configured to:
receive, by a server in an orchestration framework, a request for execution of a first pipeline that was previously executed within the orchestration framework, wherein the first pipeline includes a plurality of nodes;
retrieve, by the server in the orchestration framework, pipeline checkpoint data corresponding to the first pipeline;
initiate, based on the pipeline checkpoint data corresponding to the first pipeline, a second pipeline that is a clone of the first pipeline; and
initiate a resolver that is configured to monitor execution of the second pipeline.

2. The system of claim 1, wherein the request corresponds to a resume request for restarting execution of the first pipeline from an intermediate execution state of at least one node from the plurality of nodes in the first pipeline.

3. The system of claim 2, wherein the one or more processors are further configured to:
allocate compute resources for execution of the second pipeline, wherein the second pipeline is configured to commence execution from a resume state corresponding to the intermediate execution state of the at least one node.

4. The system of claim 2, wherein the pipeline checkpoint data includes paused state data that corresponds to the intermediate execution state.

5. The system of claim 4, wherein the paused state data includes at least one of a machine learning model, machine learning model weights, input data received by the at least one node, output data generated by the at least one node, and data corresponding to a last completed epoch.

6. The system of claim 1, wherein the request corresponds to a replay request for repeating execution of at least a portion of the first pipeline.

7. The system of claim 6, wherein the pipeline checkpoint data includes input data and output data corresponding to each of a plurality of nodes in the first pipeline.

8. The system of claim 6, wherein the one or more processors are further configured to:
allocate compute resources for execution of the second pipeline, wherein the second pipeline is configured to commence execution from a replay state that is prior to an intermediate execution state of at least one node that was active during a pause request, wherein the pause request was received while the first pipeline was previously executed within the orchestration framework.

9. The system of claim 8, wherein the replay state that is prior to the intermediate execution state of the at least one node corresponds to at least one other node from the plurality of nodes, wherein the at least one other node completed execution prior to the pause request.

10. A method comprising:
receiving, by a server in an orchestration framework, a request for execution of a first pipeline that was previously executed within the orchestration framework, wherein the first pipeline includes a plurality of nodes;
retrieving, by the server in the orchestration framework, pipeline checkpoint data corresponding to the first pipeline;
initiating, based on the pipeline checkpoint data corresponding to the first pipeline, a second pipeline that is a clone of the first pipeline; and
initiating a resolver that is configured to monitor execution of the second pipeline.

11. The method of claim 10, wherein the request corresponds to a resume request for restarting execution of the first pipeline from an intermediate execution state of at least one node from the plurality of nodes in the first pipeline.

12. The method of claim 11, further comprising:
allocating compute resources for execution of the second pipeline, wherein the second pipeline is configured to commence execution from a resume state corresponding to the intermediate execution state of the at least one node.

13. The method of claim 11, wherein the pipeline checkpoint data includes paused state data that corresponds to the intermediate execution state, and wherein the paused state data includes at least one of a machine learning model, machine learning model weights, input data received by the at least one node, output data generated by the at least one node, and data corresponding to a last completed epoch.

14. The method of claim 10, wherein the request corresponds to a replay request for repeating execution of at least a portion of the first pipeline.

15. The method of claim 14, wherein the pipeline checkpoint data includes input data and output data corresponding to each of a plurality of nodes in the first pipeline.

16. The method of claim 14, further comprising:
allocating compute resources for execution of the second pipeline, wherein the second pipeline is configured to commence execution from a replay state that is prior to an intermediate execution state of at least one node that was active during a pause request, wherein the pause request was received while the first pipeline was previously executed within the orchestration framework.

17. A system comprising:
a memory; and
one or more processors coupled to the memory, the one or more processors being configured to:
receive, by a resolver in an orchestration framework, a pause request for stopping execution of a first pipeline that includes a plurality of nodes;
identify at least one active node from the plurality of nodes that is currently executing;
send a pause command to the at least one active node from the plurality of nodes in the first pipeline;
receive paused state data that is associated with the at least one active node, wherein the paused state data corresponds to an intermediate execution state of the at least one active node; and
send pipeline checkpoint data corresponding to the first pipeline to a server, wherein the pipeline checkpoint data includes the paused state data associated with the at least one active node.

18. The system of claim 17, wherein the at least one active node from the plurality of nodes is identified based on a directed acyclic graph that is associated with the first pipeline.

19. The system of claim 17, wherein the pipeline checkpoint data includes input data and output data corresponding to each of the plurality of nodes.

20. The system of claim 17, wherein the paused state data includes at least one of a machine learning model, machine learning model weights, input data received by the at least one active node, output data generated by the at least one active node, and data corresponding to a last completed epoch.
